(19) United States
(12) Patent Application Publication
(10) Pub. No.: US 2025/0272968 A1
(43) Pub. Date: Aug. 28, 2025

(54) MULTI-THREADED VIDEO PIPELINE FOR VIDEO CONTENT RELATED TO A VIDEO ENVIRONMENT

(71) Applicant: Shure Acquisition Holdings, Inc., Niles, IL (US)

(72) Inventors: Yichong Yan, Prosper, TX (US); Nathan Seitz, Austin, TX (US); Daniel Law, Glencoe, IL (US)

(21) Appl. No.: 19/063,906

(22) Filed: Feb. 26, 2025

Related U.S. Application Data
(60) Provisional application No. 63/557,648, filed on Feb. 26, 2024.

(51) Int. Cl. G06V 10/94; G06V 10/62; G06V 10/764; G06V 10/77; G06V 20/40; G06V 40/16; H04L 12/18

(52) U.S. Cl. CPC G06V 10/94; G06V 10/62; G06V 10/764; G06V 10/7715; G06V 20/44; G06V 40/172; H04L 12/1818; G06V 2201/10

(57) ABSTRACT

Techniques are disclosed herein for providing a multi-threaded video pipeline for video content associated with a video environment. Examples may include detecting a defined event type with respect to raw video data associated with at least one video capture device located within a video environment, configuring respective video processors of a video processor pipeline associated with the at least one video capture device based at least in part on the defined event type, encoding video data associated with the at least one video capture device based at least in part on the configuration of the respective video processors, and outputting the encoded video data to a network device.

### CROSS REFERENCE TO RELATED APPLICATIONS

This application claims the benefit of U.S. Provisional Patent Application No. 63/557,648, titled “MULTI-THREADED VIDEO PIPELINE FOR VIDEO CONTENT RELATED TO A VIDEO ENVIRONMENT,” and filed on Feb. 26, 2024, the entirety of which is hereby incorporated by reference.

### TECHNICAL FIELD

Embodiments of the present disclosure relate generally to video processing and, more particularly, to systems configured to provide a multi-threaded video pipeline to transmit and process video content.

### BACKGROUND

Applicant has identified many deficiencies and problems associated with existing techniques for capturing, processing, and/or transmitting video data captured by video captured devices in a video environment. Through applied effort, ingenuity, and innovation, many of these identified deficiencies and problems have been solved by developing solutions that are configured in accordance with embodiments of the present disclosure, many examples of which are described herein.

### BRIEF SUMMARY

Various embodiments of the present disclosure are directed to apparatuses, systems, methods, and computer readable media for providing a multi-threaded video pipeline for video content related to a video environment. These characteristics as well as additional features, functions, and details of various embodiments are described below. The claims set forth herein further serve as a summary of this disclosure.

### BRIEF DESCRIPTION OF THE DRAWINGS

Having thus described some embodiments in general terms, reference will now be made to the accompanying drawings, which are not necessarily drawn to scale, and wherein:

FIG. 1 illustrates an example video processing system configured to execute audio/video (AV) processing operations related to video events in accordance with one or more embodiments disclosed herein;

FIG. 2 illustrates an example AV processing apparatus configured in accordance with one or more embodiments disclosed herein;

FIG. 3 illustrates an example video pipeline in accordance with one or more embodiments disclosed herein;

FIG. 4 illustrates an example network system in accordance with one or more embodiments disclosed herein;

FIG. 5 illustrates an example transmitter system in accordance with one or more embodiments disclosed herein;

FIG. 6 illustrates an example receiver system in accordance with one or more embodiments disclosed herein;

FIG. 7 illustrates an example video environment in accordance with one or more embodiments disclosed herein;

FIG. 8 illustrates an example method for providing a multi-threaded video pipeline for video content related to a video environment in accordance with one or more embodiments disclosed herein; and

FIG. 9 illustrates another example method for providing a multi-threaded video pipeline for video content related to a video environment in accordance with one or more embodiments disclosed herein.

### DETAILED DESCRIPTION

Various embodiments of the present disclosure will now be described more fully hereinafter with reference to the accompanying drawings, in which some, but not all embodiments of the present disclosure are shown. Indeed, the disclosure may be embodied in many different forms and should not be construed as limited to the embodiments set forth herein. Rather, these embodiments are provided so that this disclosure will satisfy applicable legal requirements.

### Overview

An audio video (AV) conferencing system may include multiple video cameras to capture video data in a video environment. The captured video data may be transmitted between devices in the video environment and/or another environment via a network. For example, a remote hub may receive and process the captured video data from the video cameras. The remote hub may also transmit the processed video data to one or more display devices in the video environment and/or another environment via a network. To process the video data, the remote hub typically utilizes a video processing pipeline configured in a modular approach such that each video processor is responsible for a single video processing task. A video processing task may include camera data acquisition, video encoding/decoding, video machine learning modeling, or another type of video processing task. Due to the variability in video codec implementations and application programming interfaces (APIs) in typical AV conferencing systems, multiple configurations for a video processing pipeline are typically predefined and provided to ensure proper functioning for video processing. However, by utilizing predefined configurations for a video processing pipeline, nonessential portions of the video data may be transmitted to the remote hub, resulting in inefficient network latencies and/or inefficient bandwidth utilization for the network. By utilizing predefined configurations for a video processing pipeline, it may also be difficult to dynamically add an additional video camera or other device to the video processing pipeline during real-time operation. Additionally, inefficient and/or unnecessary video processing by the video camera may additionally or alternatively occur.

To address these and/or other technical problems associated with traditional AV conferencing systems, various embodiments disclosed herein provide a multi-threaded video pipeline for video content related to a video environment. In some examples, configuration of a video processing pipeline is determined and/or executed at runtime with respect to video capture devices to register respective video processors to the video processing pipeline. A video pipeline may include a first video processing thread associated with encoding and a second video processing thread associated with machine learning modeling. As such, respective video processing threads associated with encoding and/or machine learning modeling may be executed based on the configuration of the video processing pipeline at runtime. Additionally or alternatively, respective video streams associated with the video capture devices may be transmitted via network and/or configured for rendering via a display of a display device based on the configuration of the video processing pipeline at runtime.

Accordingly, by utilizing real-time configuration of a video processing pipeline as disclosed herein, network latency and/or bandwidth utilization for transmitting video data may be minimized. Additionally, efficiency and/or quality of video processing by a video capture device may be additionally or alternatively improved. In some examples, the video processing pipeline may be configured as a multi-threaded pipeline to simultaneously transmit and process video. With the multi-threaded pipeline arrangement, latency may be further minimized by executing certain video processing threads asynchronously.

### Example Video Processing Systems and Methods

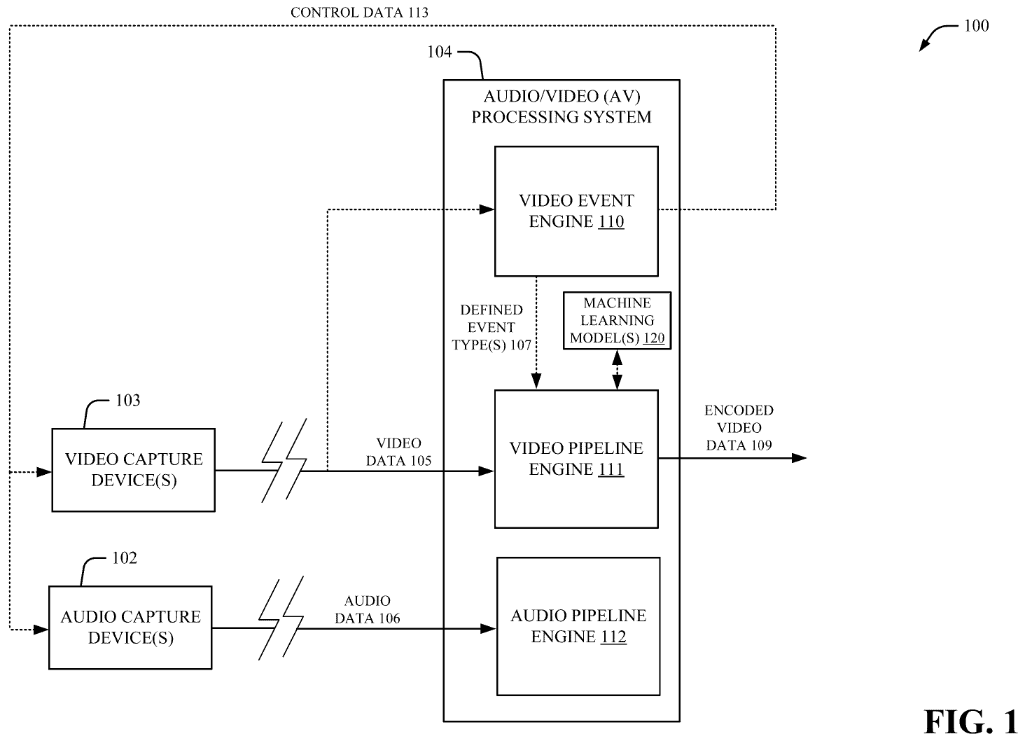

FIG. 1 illustrates a video processing system 100 that is configured to provide a multi-threaded video pipeline for video content related to a video environment, according to embodiments of the present disclosure. For example, the video processing system 100 provides real-time configuration of a video processing pipeline associated with video capture devices in a video environment. The video processing system 100 may be, for example, a video environment system, a conferencing system (e.g., a conference audio system), a video conferencing system, an audio video (AV) conferencing system, a digital conference system, etc.), a lecture hall system, a classroom system, a live event system, an automobile advanced driver assistance system (ADAS), a digital media content workstation, a broadcasting system, an augmented reality system, a virtual reality system, a gaming system, an online gaming system, or another type of video system. Additionally, the video processing system 100 may be implemented as a video processing apparatus and/or as software that is configured for execution on a network device, a video capture device (e.g., a camera device), a smartphone, a laptop, a personal computer, a digital conference system, a wireless conference unit, a video workstation device, a communication center device (e.g., a hub device), or another device. The video processing system 100 disclosed herein may additionally or alternatively be integrated into a virtual video processing system (e.g., video processing via virtual processors or virtual machines) with other audio and/or digital signal processing.

By providing real-time configuration of a video processing pipeline, the video processing system 100 may provide various improvements related to video processing such as, for example: minimizing network latency for transmitting video data over a network, minimizing bandwidth utilization for transmitting video data over a network, reducing a number of computing resources for processing video by a video capture device, and/or improving power consumption for processing video by a video capture device. The video processing system 100 may also be adapted to produce improved video signals for a video environment. Additionally or alternatively, the video processing system 100 may be adapted to produce improved audio for video signals. For example, audio for video signals may be provided with reduced noise, reduced reverberation, improved source separation, and/or a reduction in other undesirable audio artifacts. A video environment may be an indoor environment, an outdoor environment, an entertainment environment, a room, a conference room, a meeting room, a classroom, a lecture hall, a performance hall, a broadcasting environment, a sports stadium or arena, a virtual environment, an automobile environment, or another type of video environment.

In some examples, the video processing system 100 may provide video streams for rendering via one or more display devices. In some examples, a display device may receive a video stream via a physical interface protocol such as a universal serial bus (USB) communication protocols or another type of communication protocol. In some examples, a display device may receive a video stream via a network communication protocol such as an Internet Protocol (IP), IP over Ethernet (IPoE), or other network communication protocol. In some examples, a display device may be a physical device such as a smartphone, a laptop, a personal computer, a digital conference device, a wireless conference unit, an augmented reality device, a virtual reality device, or another type of display device. In some examples, a display device may be a virtual camera or another type of virtual device.

The video processing system 100 includes one or more video capture devices 103. The one or more video capture devices 103 may respectively be devices configured to capture video related to the one or more sound sources. The one or more video capture devices 103 may include one or more sensors configured for capturing video by converting light into one or more electrical signals. The video captured by the one or more video capture devices 103 may also be converted into video data 105. In an example, the one or more video capture devices 103 are one or more video cameras.

In some examples, the video processing system 100 additionally includes one or more audio capture devices 102. The one or more audio capture devices 102 may respectively be devices configured to capture audio from one or more sound sources. The one or more audio capture devices 102 may include one or more sensors configured for capturing audio by converting sound into one or more electrical signals. The audio captured by the one or more audio capture devices 102 may also be converted into audio data 106. The audio data 106 may be a digital audio data or, alternatively, analog audio data, related to the one or more electrical signals. In some examples, the audio data 106 may be beamformed audio data.

In an example, the one or more audio capture devices 102 are one or more microphones arrays. For example, the one or more audio capture devices 102 may correspond to one or more array microphones, one or more beamformed lobes of an array microphone, one or more linear array microphones, one or more ceiling array microphones, one or more table array microphones, or another type of array microphone. In alternate examples, the one or more audio capture devices 102 are another type of capture device such as, but not limited to, one or more condenser microphones, one or more micro-electromechanical systems (MEMS) microphones, one or more dynamic microphones, one or more piezoelectric microphones, one or more virtual microphones, one or more network microphones, one or more ribbon microphones, and/or another type of microphone configured to capture audio. It is to be appreciated that, in certain examples, the one or more audio capture devices 102 may additionally or alternatively include one or more infrared capture devices, one or more sensor devices, one or more video capture devices (e.g., one or more video capture devices 103), and/or one or more other types of audio capture devices.

The one or more video capture devices 103 and/or the one or more audio capture devices 102 may be positioned within a particular video environment. In some examples, the video data 105 includes video frames related to a speaker associated with the audio data 106. In some examples, the one or more video capture devices 103 and the one or more audio capture devices 102 may be integrated together in one or more capture devices.

The video processing system 100 also comprises an audio/video (AV) processing system 104. The AV processing system 104 may be configured to perform one or more video processes and/or one or more audio processes with respect to the video data 105 and/or the audio data 106 to provide encoded video data 109. The AV processing system 104 depicted in FIG. 1 includes a video event engine 110, a video pipeline engine 111, and/or an audio pipeline engine 112.

The video event engine 110 detects events with respect to the video data 105. In some examples, the video event engine 110 detects one or more defined event types 107 with respect to raw video data related to the one or more video capture devices 103, audio data related to the one or more audio capture devices 102, sensor data provided by one or more sensors of at least one video capture device of the one or more video capture devices 103, sensor data provided by at least one audio capture device of the one or more audio capture devices 102, and/or machine learning model output provided by one or more machine learning models (e.g., a set of machine learning models 120). The raw video data may include raw or minimally processed visual information extracted from a video stream provided by the one or more video capture devices 103. In some examples, the raw video data includes a sequence of digital video frames respectively including pixel values that encode color information and/or brightness information. In some examples, the raw video data related to the one or more video capture devices 103 may include video data and audio data. A defined event type may include one or more of: a runtime indicator, an event flag, a view score, a person detection indicator, an object detection indictor, a field of view change indicator, an object change indicator, a user device event (e.g., an electronic interface event), a video processor event, or another type of defined event type. The runtime indicator may indicate an initiation of one or more video processing tasks related to the one or more video capture devices 103. In some examples, the raw video includes at least a portion of the video data 105. The raw video may also include unprocessed video content at the initiation of the one or more video processing tasks related to the one or more video capture devices 103.

In some examples, a defined event of the one or more defined event types 107 may be linked to a physical event occurring in real-time in the video environment. Additionally, a defined event of the one or more defined event types 107 may be related to one or more types of entities in the video environment such as, but not limited to: a person, a speaker, a singer, a musician, a performer, an object, an instrument, a collaboration surface or area, a whiteboard, a chalkboard, a display board, etc. For example, a defined event may be related to a human face appearing in a field of view of at least one video capture device from the one or more video capture devices 103. In another example, a defined event may be related to detection of a frontal view of a person's face in one or more video frames captured by at least one video capture device from the one or more video capture devices 103. In yet another example, a defined event may be related to a certain degree of pixel changes within one or more video frames with respect to a whiteboard in the video environment that is within a field of view of at least one video capture device from the one or more video capture devices 103. However, it is to be appreciated that, in certain examples, a defined event may be related to one or more other types of physical events occurring in the video environment.

Additionally, the runtime indicator may be generated based on an action associated with the one or more video capture devices 103, a user device, a communication center device, and/or another device. In some examples, the runtime indicator may be generated based on a user application action initiated via a user interface of a user device. In some examples, the user application action may be correlated to a user interaction with respect to an interactive graphical element of the user interface. The user interaction may provide a selection of a particular video capture device and/or a particular portion of a video frame provided by a video capture device. In some examples, the user interaction may indicate a particular person or object within a video frame via a bounding box or another type of digital selection via the user interface. In some examples, the interactive graphical element is a dropdown menu that provides a list of video capture devices within a video environment. In some examples, the runtime indicator may be generated based on a codec action (e.g., a conference hub codec action) initiated via a communication center device. In some examples, the codec action may be correlated to a configuration of a video pipeline related to the one or more video capture devices 103. In some examples, the configuration of the video pipeline may include one or more of: video frame encoding settings, video frame size, frame rate, color depth settings, bit rate settings, frame format settings, resolution format settings, keyframe intervals, encoding profile selections, and/or another type of configuration parameter as determined by the communication center device. In some examples, the runtime indicator may be generated based on an audio pipeline action initiated via an audio pipeline related to the one or more video capture devices 103. In some examples, the audio pipeline may process the audio data 106 captured by the one or more audio capture devices 102.

The event flag may provide an event indication related to one or more possible types of events with respect to the video data 105. The event flag may additionally or alternatively provide an event indication related to one or more possible types of video processing threads capable of being executed via one or more video processors. The view score may provide a weighted score for features extracted from the video data 105. The view score may refer to a numerical or categorical value that represents quality of a view captured by the one or more video capture device 103. The quality of the view may be determined with respect to one or more targets of interest in the video environment. In some examples, the view score may be generated based on one or more features extracted from the video data 105, the audio data 106, and/or metadata. Additionally, the view score may represent a view quality for a particular object or person detected in the video data 105. The object detection indicator may indicate whether an object or person is detected in the video data 105. In some examples, the object detection indicator may include a facial recognition indicator related to detection of a face in the video data 105.

The video pipeline engine 111 utilizes the one or more defined event types 107 to provide encoded video data 109 related to the one or more video capture devices 103. In some examples, the video pipeline engine 111 configures respective video processors of a video processor pipeline related to the one or more video capture devices 103 based at least in part on the one or more defined event types 107. In some examples, the video pipeline engine 111 configures video processing threads for the video processor pipeline based at least in part on the one or more defined event types 107. Configuration of the video processing threads may include: turning particular video processing threads on or off, setting particular parameters for particular video processing threads, initiating particular video related tasks, initiating a particular type of encoding task, initiating a video data acquisition task, initiating execution of a particular machine learning model, enabling speech separation with respect to a video processing thread, modifying one or more video frames related to a video processing thread, enabling an optical character recognition (OCR) task related to one or more video frames related to a video processing thread, and/or one or more other types of configurations for a video processing thread. In some examples, modifying one or more video frames related to a video processing thread includes enabling a digital zoom, pan, and/or zoom related to a particular region in one or more video frames related to a video processing thread. In some examples, modifying one or more video frames related to a video processing thread includes combining two or more video frames via video frame stitching. The combined video fames may be from a single video capture device or different video capture devices. The particular region may include a detected person, a person associated with a digital identifier, a person related to speech separation, a group of people, an object of interest, a whiteboard region, etc. Based on the configuration of the respective video processors, the video pipeline engine 111 encodes video data related to the one or more video capture devices 103 to generate the encoded video data 109.

The encoded video data 109 may be video data that is processed and/or compressed using one or more video encoding techniques. For example, the encoded video data 109 may be generated based on the configuration of respective video processors. Additionally, the encoded video data 109 may include compressed video frames, metadata, and/or other information related to the video captured by one or more video capture devices 103. In some examples, the encoded video data 109 may be formatted according to one or more video coding standards or protocols. In some examples, the encoded video data 109 may be configured for transmission over a network or storage on a device with reduced bandwidth or storage requirements compared to raw or uncompressed video data.

In some examples, the video event engine 110 transmits control data 113 to the one or more video capture devices 103 to configure the respective video processors of the video processor pipeline. The control data 113 may be utilized to control and/or configure one or more portions of the one or more video capture devices 103. The control data 113 may be utilized to control and/or configure one or more portions of one or more video processors of the one or more video capture devices 103. In some examples, the control data 113 may be utilized to control and/or configure one or more machine learning models utilized by the one or more video capture devices 103.

In some examples, the control data 113 may include one or more configuration parameters for the one or more video capture devices 103 such as, but not limited to one or more: camera settings, camera selection, camera focus direction, pan, zoom, crop, microphone array settings, beam steering settings, video encoding settings, video frame transmission settings, video frame size, frame rate, color depth settings, frame format settings, resolution format settings, and/or another type of configuration parameter for the one or more video capture devices 103.

In some examples, the control data 113 may include a selection of a particular machine learning model from the set of machine learning models 120 to be executed in parallel to capturing video content via the one or more video capture devices 103. The selected machine learning model may provide metadata such as, but not limited to: information related to video frames, video features, object detection features, object classifications, person recognition features, person classifications, three-dimensional coordinates, facial features, mouth features, head pose angles, eye features, eye gaze angles, emotion predictions, active speaking classifications, camera locations, camera poses, depth estimation, color format, frame orientation, frame rotation, natural language processing, video quality, and/or other metadata. In some examples, color format metadata may indicate a type of color format (e.g., RGB, YUV, NV12, etc.) related to video frames. In some examples, frame orientation metadata may indicate whether video frames are oriented as a landscape orientation or a portrait orientation. In some examples, frame rotation metadata may indicate whether a video frame is rotated horizontally, vertically, diagonally, etc. In some examples, at least a portion of the metadata may be provided by the one or more video capture devices 103, the one or more audio capture devices 102, the video pipeline engine 111, and/or the audio pipeline engine 112 rather than the set of machine learning models 120.

In some examples, the control data 113 may enable or disable one or more functionalities associated with the one or more video capture devices 103. For instance, the control data 113 may include one or more control signals and/or configuration data to enable or disable one or more video processing tasks. A video processing task may include camera data acquisition, video encoding/decoding, video machine learning inferencing, pre-processing of video data for video machine learning inferencing, rendering of decoded video frames, or another type of video processing task. Additionally, a video processing task may result in generation of metadata, video metrics, object detection, and/or people detection associated with video frames. In some examples, pre-processing of video data may include resampling, scaling, color space conversions, data type conversions, channel sequence conversions, and/or other processing of video data.

In some examples, the video pipeline engine 111 outputs the encoded video data 109 to a network device. The network device may be a network switch, a user device, a display device, an edge device, or another type of device communicatively coupled to the video processing system 100 via a network. The network may be a communication network or any suitable network or combination of networks that supports any appropriate protocol suitable for communication of the encoded video data 109 to and from devices. For example, the network may utilize a network communication protocol such as IP, IPoE, or other network communication protocol to transmit the encoded video data 109 via IP datagrams. In some examples, the network may transmit the encoded video data 109 via one or more network layers such as a data link layer. In some examples, the encoded video data 109 may be encapsulated according to a network communication protocol to provide encapsulated video data packets. In some examples, the network is implemented as the Internet, a wireless network, a wired network (e.g., Ethernet), a local area network (LAN), a Wide Area Network (WANs), Bluetooth, Near Field Communication (NFC), or any other type of network that provides communications between one or more components of a network architecture.

Accordingly, the AV processing system 104 may provide improved video processing as compared to traditional video processing techniques. The AV processing system 104 may additionally or alternatively provide improved audio for the video environment. For example, the encoded video data 109 may be provided with improved accuracy of localization of a sound source in the video environment. The encoded video data 109 may be additionally or alternatively provided with improved audio signals with reduced noise, reverberation, and/or other undesirable audio artifacts even in view of exacting video latency requirements for the encoded video data 109. For example, the AV processing system 104 may remove or suppress undesirable noise for predefined noise locations in the video environment to provide the encoded video data 109.

The AV processing system 104 may also employ fewer computing resources when compared to traditional video processing systems that are used for video processing. Additionally or alternatively, the AV processing system 104 may be configured to deploy a smaller number of memory resources allocated to video processing, beamforming, source separation, denoising, dereverberation, and/or other audio processing for the encoded video data 109. In some examples, the AV processing system 104 may be configured to improve processing speed of video processing operations, beamforming operations, source separation operations, denoising operations, dereverberation operations, and/or audio filtering operations. These improvements may enable an improved AV processing systems to be deployed with respect to cameras, microphones or other hardware/software configurations where processing and memory resources are limited, and/or where processing speed and efficiency is important.

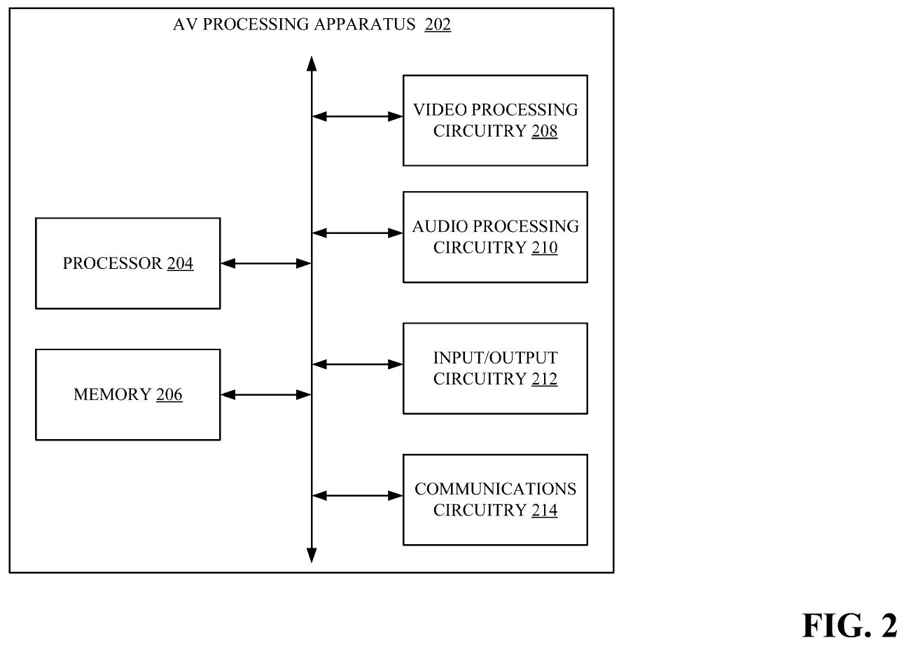

FIG. 2 illustrates an example AV processing apparatus 202 configured in accordance with one or more embodiments of the present disclosure. The AV processing apparatus 202 may be configured to perform one or more techniques described in FIG. 1 and/or one or more other techniques described herein.

The AV processing apparatus 202 may be a computing system communicatively coupled with one or more circuit modules related to video processing and/or audio processing. The AV processing apparatus 202 may comprise or otherwise be in communication with a processor 204, a memory 206, video processing circuitry 208, audio processing circuitry 210, input/output circuitry 212, and/or communications circuitry 214. In some embodiments, the processor 204 (which may comprise multiple or co-processors or any other processing circuitry associated with the processor) may be in communication with the memory 206.

The memory 206 may comprise non-transitory memory circuitry and may comprise one or more volatile and/or non-volatile memories. In some examples, the memory 206 may be an electronic storage device (e.g., a computer readable storage medium) configured to store data that may be retrievable by the processor 204. In some examples, the data stored in the memory 206 may comprise video data, audio data, stereo audio signal data, mono audio signal data, radio frequency signal data, audio features, video features, control data, machine learning data, defined event type data, or the like, for enabling the AV processing apparatus 202 to carry out various functions or methods in accordance with embodiments of the present disclosure, described herein.

In some examples, the processor 204 may be embodied in a number of different ways. For example, the processor 204 may be embodied as one or more of various hardware processing means such as a central processing unit (CPU), a microprocessor, a coprocessor, a DSP, a field programmable gate array (FPGA), a neural processing unit (NPU), a graphics processing unit (GPU), a system on chip (SoC), a cloud server processing element, a controller, or a processing element with or without an accompanying DSP. The processor 204 may also be embodied in various other processing circuitry including integrated circuits such as, for example, a microcontroller unit (MCU), an ASIC (application specific integrated circuit), a hardware accelerator, a cloud computing chip, or a special-purpose electronic chip. Furthermore, in some embodiments, the processor 204 may comprise one or more processing cores configured to perform independently. A multi-core processor may enable multiprocessing within a single physical package. Additionally or alternatively, the processor 204 may comprise one or more processors configured in tandem via a bus to enable independent execution of instructions, pipelining, and/or multithreading.

In some examples, the processor 204 may be configured to execute instructions, such as computer program code or instructions, stored in the memory 206 or otherwise accessible to the processor 204. Alternatively or additionally, the processor 204 may be configured to execute hard-coded functionality. As such, whether configured by hardware or software instructions, or by a combination thereof, the processor 204 may represent a computing entity (e.g., physically embodied in circuitry) configured to perform operations according to an embodiment of the present disclosure described herein. For example, when the processor 204 is embodied as an CPU, DSP, ARM, FPGA, ASIC, or similar, the processor may be configured as hardware for conducting the operations of an embodiment of the disclosure. Alternatively, when the processor 204 is embodied to execute software or computer program instructions, the instructions may specifically configure the processor 204 to perform the algorithms and/or operations described herein when the instructions are executed. However, in some examples, the processor 204 may be a processor of a device specifically configured to employ an embodiment of the present disclosure by further configuration of the processor using instructions for performing the algorithms and/or operations described herein. The processor 204 may further comprise a clock, an arithmetic logic unit (ALU) and logic gates configured to support operation of the processor 204, among other things.

In one or more examples, the AV processing apparatus 202 includes the video processing circuitry 208. The video processing circuitry 208 may be any means embodied in either hardware or a combination of hardware and software that is configured to perform one or more functions disclosed herein related to the video event engine 110 and/or the video pipeline engine 111. For example, the video processing circuitry 208 may be any means embodied in either hardware or a combination of hardware and software that is configured to perform one or more functions disclosed herein related to processing of the video data 105 received from the one or more video capture devices 103. In one or more examples, the AV processing apparatus 202 includes the audio processing circuitry 210. The audio processing circuitry 210 may be any means embodied in either hardware or a combination of hardware and software that is configured to perform one or more functions disclosed herein related to the audio pipeline engine 112 and/or other audio processing of the audio data 106 received from the one or more audio capture devices 102.

In some examples, the AV processing apparatus 202 includes the input/output circuitry 212 that may, in turn, be in communication with processor 204 to provide output to the user and, in some examples, to receive an indication of a user input. The input/output circuitry 212 may comprise a user interface and may comprise a display. In some examples, the input/output circuitry 212 may also comprise a keyboard, a touch screen, touch areas, soft keys, buttons, knobs, or other input/output mechanisms.

In some examples, the AV processing apparatus 202 includes the communications circuitry 214. The communications circuitry 214 may be any means embodied in either hardware or a combination of hardware and software that is configured to receive and/or transmit data from/to a network and/or any other device or module in communication with the AV processing apparatus 202. In this regard, the communications circuitry 214 may comprise, for example, an antenna or one or more other communication devices for enabling communications with a wired or wireless communication network. For example, the communications circuitry 214 may comprise antennae, one or more network interface cards, buses, switches, routers, modems, and supporting hardware and/or software, or any other device suitable for enabling communications via a network. Additionally or alternatively, the communications circuitry 214 may comprise the circuitry for interacting with the antenna/antennae to cause transmission of signals via the antenna/antennae or to handle receipt of signals received via the antenna/antennae.

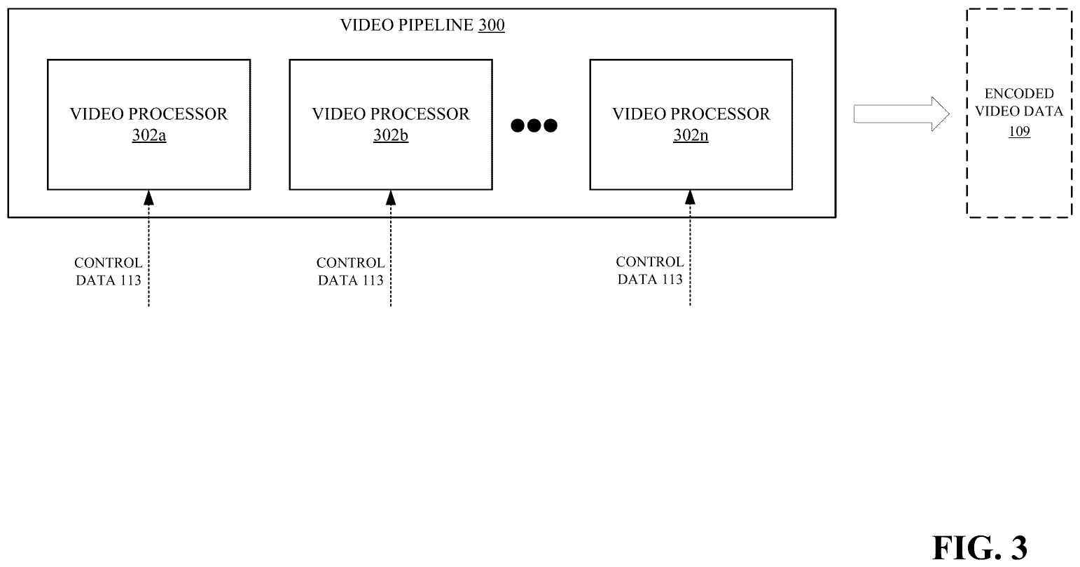

FIG. 3 illustrates a video pipeline 300 according to one or more embodiments of the present disclosure. The video pipeline 300 includes one or more video processors 302a-n. The one or more video processors 302a-n correspond to one or more video processors of the one or more video capture devices 103. Additionally, the one or more video processors 302a-n may be configured to provide the encoded video data 109. In some examples, the one or more video processors 302a-n may be configured at runtime related to the one or more video capture devices 103. The one or more video processors 302a-n may be configured based on the control data 113. For example, the video event engine 110 may generate the control data 113 based on the one or more defined event types 107 related to the video data 105. Additionally, the video event engine 110 may provide the control data 113 to one or more of the one or more video processors 302a-n. In some examples, the video event engine 110 may provide the control data 113 to one or more of the one or more video processors 302a-n at runtime with respect to video capture devices. Based on the configuration of the one or more video processors 302a-n, the video pipeline 300 may output the encoded video data 109.

In some examples, a video processor of the one or more video processors 302a-n may be configured to encode and/or transmit video data. As such, in some examples, the control data 113 may be utilized to: turn encoding on or off, turn transmission of encoded video frames on or off, configure parameters for the encoding, and/or configure parameters for transmitting video frames. In some examples, a video processor of the one or more video processors 302a-n may be configured to generate metadata associated with video data. As such, in some examples, the control data 113 may be additionally or alternatively utilized to: initiate generation and/or transmission of metadata related to video data, configure the type of metadata to be generated and/or transmitted, etc. In some examples, a video processor of the one or more video processors 302a-n may be configured to extract video features from video data. As such, in some examples, the control data 113 may be additionally or alternatively utilized to: initiate feature extraction with respect to video data, configure parameters or types of features to be extracted, etc. In some examples, a video processor of the one or more video processors 302a-n may be configured to execute one or more machine learning models. As such, in some examples, the control data 113 may be additionally or alternatively utilized to identify a particular machine learning model to execute, provide input data to a particular machine learning model, etc.

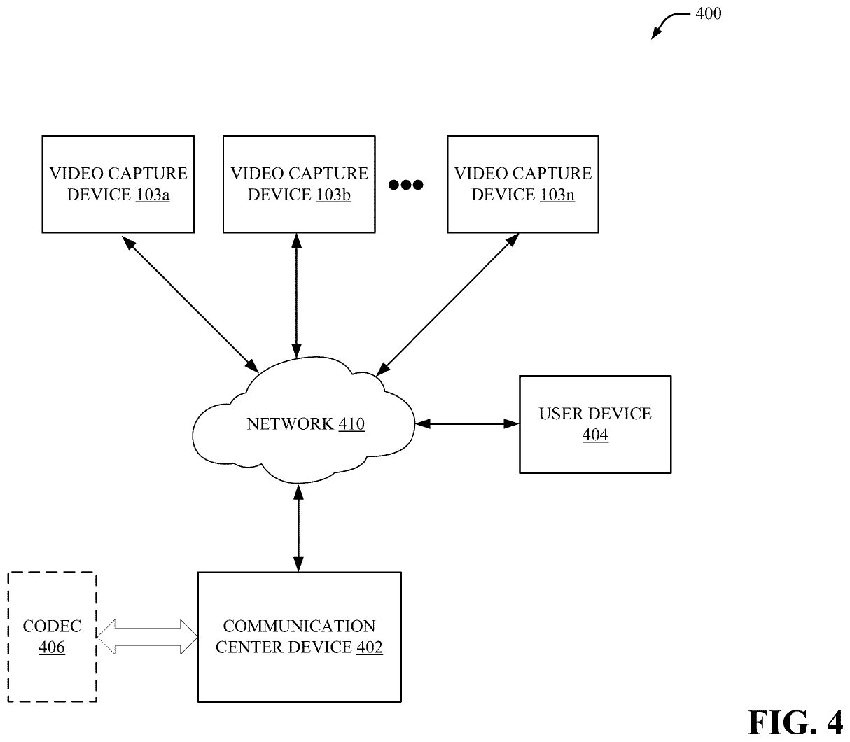

FIG. 4 illustrates a network system 400 according to one or more embodiments of the present disclosure. The network system 400 includes the one or more video capture devices 103, a communication center device 402, and/or a user device 404. In some examples, at least one of the one or more video capture devices 103 includes the AV processing system 104 and/or the AV processing apparatus 202. Alternatively, in some examples, the communication center device 402 includes the AV processing system 104 and/or the AV processing apparatus 202. In some examples, the communication center device 402 includes the AV processing system 104 and/or the AV processing apparatus 202. The one or more video capture devices 103, the communication center device 402, and/or the user device 404 may be communicatively coupled via a network 410. In some examples, the network 410 includes one or more network devices such as one or more network switches and/or one or more network routers. The communication center device 402 may be a hub device that supports Ethernet, voice over Internet Protocol (VOIP), and/or one or more network communication protocols. In some examples, the communication center device 402 may enable the one or more video capture devices 103 to be configured as a set of network-connected video devices for a video environment.

The communication center device 402 may provide video and/or audio from the one or more video capture devices 103 to the user device 404. In some examples, the user device 404 may be configured as a host device for a video conference enabled by the one or more video capture devices 103 and the communication center device 402. For instance, the user device 404 may be configured as a host of a codec 406 that receives a video stream (e.g., the encoded video data 109) provided by the one or more video capture device 103. In some examples, the codec 406 is a video conference codec configured for video conferencing. The user device 404 may be communicatively coupled to the communication center device 402 via the network 410 or another direct IP connection. Alternatively, the user device 404 may be communicatively coupled to the communication center device 402 via a direct wired connection such as a USB connection or another type of hardware interface that supports a display protocol. In some examples, the user device 404 may also be communicatively coupled to the one or more video capture devices 103 via the network 410. In some examples, the user device 404 may correspond to the communication center device 402 such that the user device 404 manages video and/or audio from the one or more video capture devices 103. In such examples, the user device 404 includes the AV processing system 104 and/or the AV processing apparatus 202. In some examples, the user device 404 may additionally or alternatively be configured as a video capture device. As such, video and/or audio from the user device 404 may be provided in addition to video and/or audio from one or more video capture devices 103.

The user device 404 may be a smartphone, a laptop, a personal computer, a digital conference device, a wireless conference unit, an augmented reality device, a virtual reality device, or another type of user device. In some examples, the user device 404 includes a display and/or a graphical user interface that renders video content provided by the one or more video capture devices 103. In some examples, the user device 404 may provide a virtual video capture device and/or a virtual audio capture device for the network system 400. Additionally, video and/or audio from the virtual devices may be routed to the codec 406 in addition to video and/or audio from one or more video capture devices 103.

In some examples, the user device 404 may provide user device data to the communication center device 402 and/or the one or more video capture devices 103 to facilitate interactions with the communication center device 402 and/or the one or more video capture devices 103. The user device data may include data such as, but not limited to: supported video formats, network interface card (NIC) bandwidth, a role identifier (e.g., hub or video capture device), a device identifier (e.g., a media access control (MAC) address or another type of identifier), a user identifier, and/or other data related to the user device 404. In some examples, one or more portions of the user device data may be provided via an electronic interface of the user device 404. Additionally or alternatively, one or more portions of the user device data may be provided via metadata or a user device profile for the user device 404.

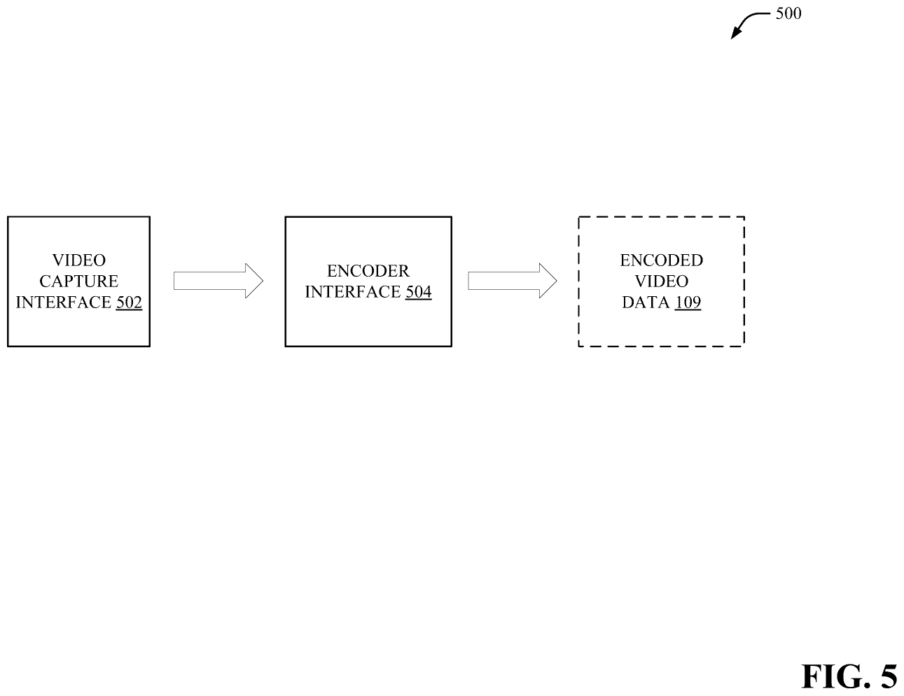

FIG. 5 illustrates a transmitter system 500 according to one or more embodiments of the present disclosure. The transmitter system 500 may be included in and/or otherwise associated with the one or more video capture devices 103. In some examples, the video pipeline engine 111 may include the transmitter system 500. The transmitter system 500 includes a video capture interface 502 and/or an encoder interface 504. The video capture interface 502 may capture and/or receive one or more portions of video data (e.g., the video data 105) associated with the one or more video capture devices 103. The one or more portions of the video data (e.g., the video data 105) captured and/or received by the video capture interface 502 may be raw video data. In some examples, the video capture interface 502 includes one or more imagers such as one or more camera lenses and/or one or more sensors to capture the video data 105. In some examples, the video capture interface 502 may utilize a communication protocol and/or a communication connection such as a USB connection, a camera serial interface (CSI) connection, a peripheral component interconnect express (PCIe) connection, an IP connection, or another type of connection to couple the video capture interface 502 to the encoder interface 504.

The encoder interface 504 may encode the video data captured and/or received by the video capture interface 502. In some examples, the encoder interface 504 may transform the video data captured and/or received by the video capture interface 502 into one or more portions of the encoded video data 109. The encoder interface 504 may also act as an interface between the one or more video capture devices 103 and the network 410. In some examples, the encoder interface 504 may encode video data via a particular encoding mode (e.g., a first mode for encoding and not transmitting video, a second mode for encoding and transmitting video data, or a third mode for not encoding and not transmitting video data) based on a runtime configuration of a video processor pipeline. In some examples, the encoder interface 504 may configure the one or more portions of the encoded video data 109 as video data packets (e.g., IP datagrams) for transmission via the network 410. For instance, the encoder interface 504 may reformat the video data captured and/or received by the video capture interface 502 into video data IP datagrams by encapsulating the video data IP datagrams via Ethernet frames. In some examples, the encoded video data 109 may include audio data and/or may be synchronized with the audio pipeline engine 112.

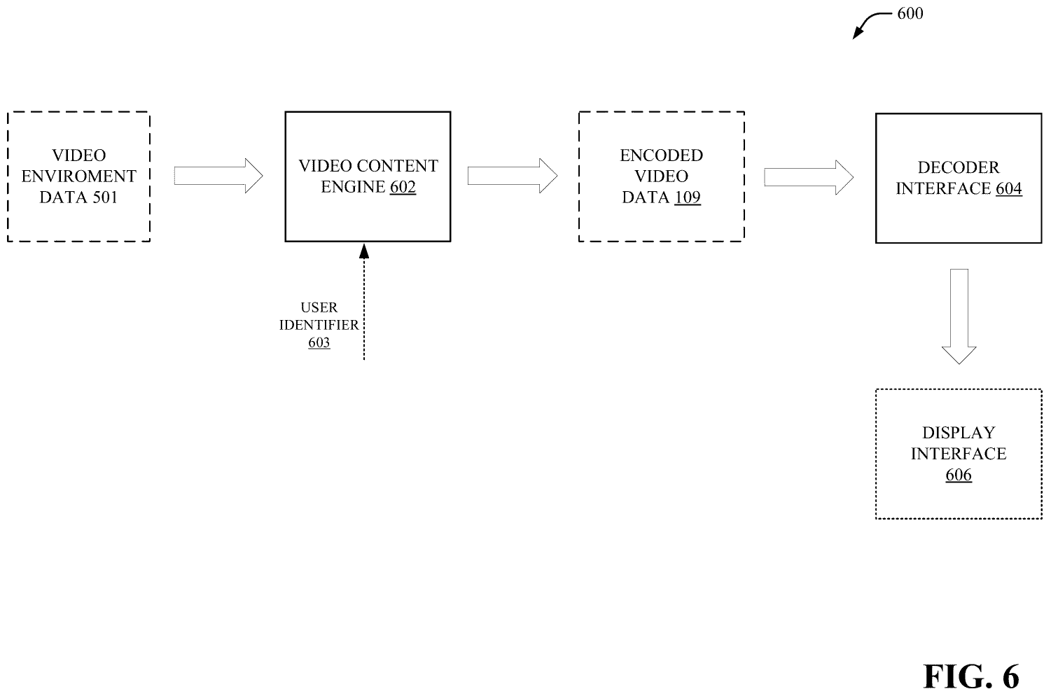

FIG. 6 illustrates a receiver system 600 according to one or more embodiments of the present disclosure. The receiver system 600 may be included in and/or otherwise associated with the communication center device 402. The receiver system 600 includes a video content engine 602 and/or a decoder interface 604. The video content engine 602 may receive network content from respective video capture devices and/or machine learning models in a video environment. The network content may include metadata, video content, audio content, and/or other content provided by respective video capture devices and/or machine learning models. The video content engine 602 may also provide video data based on the network content received from the content from respective video environments. In an example, the video content engine 602 may receive video environment data 501. In some examples, the video content engine 602 may provide the encoded video data 109 based on the video environment data 501. For example, the video content engine 602 may extract a payload that includes the encoded video data 109 from the video environment data 501.

In some examples, the video environment data 501 includes multiple captures of a person from different angles provided by different video capture devices. In some examples, the video environment data 501 additionally or alternatively includes a predicted view quality score for each of the viewing angles. As such, the video content engine 602 may determine which viewing angle is an optimal viewing angle such that a corresponding portion of the encoded video data 109 (e.g., corresponding encoded video frames) are provided to the decoder interface 604.

The encoded video data 109 may be provided to the decoder interface 604 to transform the encoded video data 109 into decoded video content for rendering via a display interface 606. In some examples, the decoder interface 604 may determine decoding parameters, frame types, and/or other decoding information for video frames from the encoded video data 109. The display interface 606 may be a display and/or a graphical user interface of a user device (e.g., the user device 404).

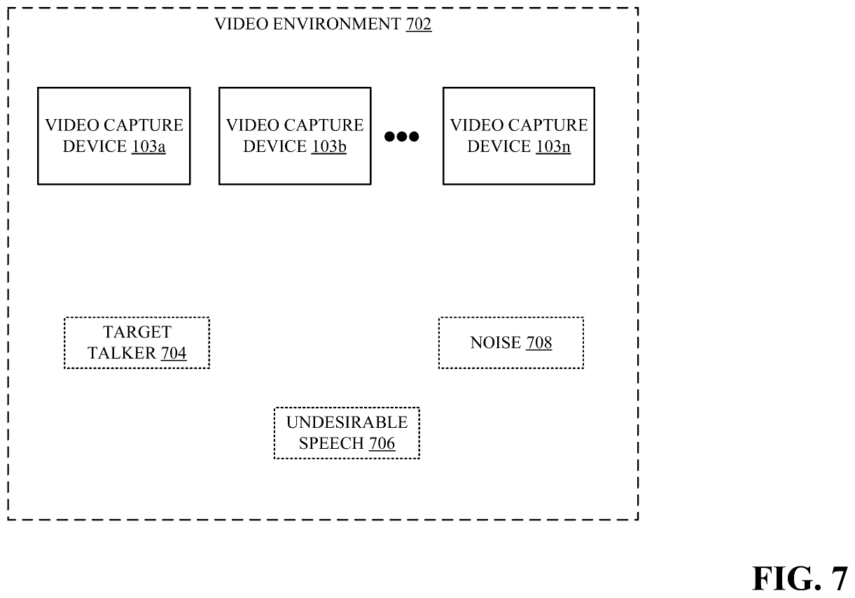

FIG. 7 illustrates an example video environment 702 according to one or more embodiments of the present disclosure. The video environment 702 may be an indoor environment, an outdoor environment, an entertainment environment, a room, a conference room, a meeting room, a classroom, a lecture hall, a performance hall, a broadcasting environment, a sports stadium or arena, a virtual environment, an automobile environment, or another type of video environment. The video environment 702 includes at least the one or more video capture devices 103a-n that are respectively capable of capturing video and/or audio from one or more sources and/or other audio in the video environment 702. For example, the one or more video capture devices 103a-n 102 may capture video and/or audio (e.g., the video data 105 and/or the audio data 106) associated with a target talker 704, undesirable speech 706, and/or noise 708 in the video environment 702. In some examples, the one or more video capture devices 103a-n recognize the target talker 704, modifies a video capture process, and/or steers one or more audio beams based on the control data 113.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices/entities, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time.

In some example embodiments, retrieval, loading, and/or execution may be performed in parallel such that multiple instructions are retrieved, loaded, and/or executed together. Thus, such embodiments may produce specifically-configured machines performing the steps or operations specified in the block diagrams and flowchart illustrations. Accordingly, the block diagrams and flowchart illustrations support various combinations of embodiments for performing the specified instructions, operations, or steps.

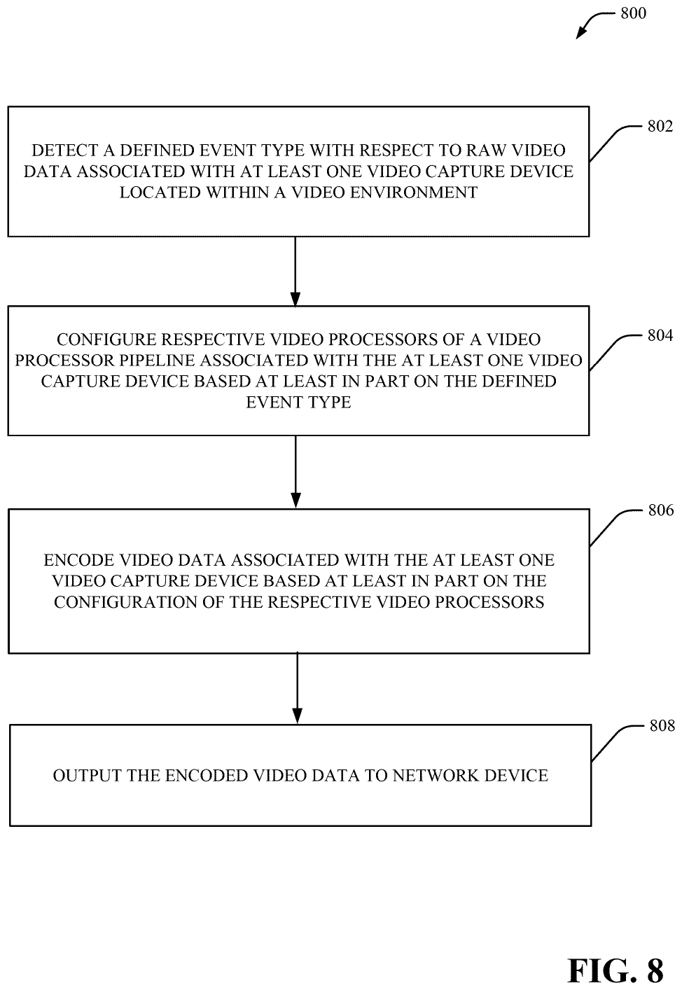

FIG. 8 is a flowchart diagram of an example process 800 for providing a multi-threaded video pipeline for video content related to a video environment, in accordance with, for example, the AV processing apparatus 202 illustrated in FIG. 2. Via the various operations of the process 800, the AV processing apparatus 202 may enhance quality, reliability, and/or source separation of video data for rendering via a display interface.

The process 800 begins at operation 802 that detects (e.g., by the video processing circuitry 208 and/or the audio processing circuitry 210) a defined event type with respect to raw video data associated with at least one video capture device located within a video environment. The video environment may be an indoor environment, an outdoor environment, an entertainment environment, a room, a conference room, a meeting room, a classroom, a lecture hall, a performance hall, a broadcasting environment, a sports stadium or arena, a virtual environment, an automobile environment, or another type of video environment. The defined event type may include one or more of: a runtime indicator, an event flag, a view score, a person detection indicator, an object detection indictor, a field of view change indicator, an object change indicator, a user device event (e.g., an electronic interface event), a video processor event, or another type of defined event type. In some examples, the defined event type is associated with a user application action associated with a user device. In some examples, the defined event type is associated with a codec action associated with a communication center device communicatively coupled to the at least one video capture device via a network. In some examples, the defined event type is associated with video processor action associated with the video processor pipeline. In some examples, the defined event type is associated with a machine learning model event associated with the video processor pipeline. A machine learning model event may correspond to a particular prediction, insight, inference, and/or classification determined by a machine learning model. In some examples, the defined event type is associated with an audio pipeline action for an audio pipeline associated with the video processor pipeline. In some examples, the defined event type is associated with a machine learning model event associated with an audio pipeline. In some examples, the defined event type is associated with sensor data provided by one or more sensors of the at least one video capture device. For example, the sensor data may include motion sensor data, proximity sensor data, radar sensor data, LiDAR sensor data, and/or other sensor data to facilitate detection of a person or object of interest in the video environment.

The process 800 also includes an operation 804 that configures (e.g., by the video processing circuitry 208) respective video processors of a video processor pipeline associated with the at least one video capture device based at least in part on the defined event type. Configuration of the video processing threads may include: turning particular video processing threads on or off, setting particular parameters for particular video processing threads, initiating particular video related tasks, initiating a particular type of encoding task, initiating a video data acquisition task, initiating execution of a particular machine learning model, enabling speech separation with respect to a video processing thread, modifying one or more video frames associated with a video processing thread, enabling an optical character recognition (OCR) task associated with one or more video frames associated with a video processing thread, and/or one or more other types of configurations for a video processing thread.

In some examples, the defined event type corresponds to an event indicator set associated with a feature set for the raw video data. For example, the event indicator set may be associated with one or more events with respect to the feature set. In some examples, the event indicator set may include a plurality of indicators or flags associated with events or conditions detected in raw video data. In some examples, the event indicator set may be determined based on the feature set extracted from the raw video data, where respective event indicators in the event indicator sets may correspond to a specific event, condition, or attribute identified within the video content. In some examples, the event indicator set may include binary flags, numerical values, or other data types that represent the presence or absence of certain events or features in the raw video data. In some examples, the event indicator set may be utilized to trigger or configure various video processing operations and/or to provide metadata regarding video content. An event may include one or more of: an inclusion of a particular type of feature in the feature set, a particular classification or label being determined for a feature in the feature set, a particular number of features in the feature set satisfying a defined threshold value, a particular view score being determined based on the feature set, or another type of event associated with the feature set. Furthermore, the process 800 additionally or alternatively includes an operation that configures the respective video processors of the video processor pipeline based at least in part on the event indicator set.

In some examples, the defined event type additionally or alternatively corresponds to a view score associated with the raw video data. Furthermore, the process 800 additionally or alternatively includes an operation that configures the respective video processors of the video processor pipeline based at least in part on the view score.

In some examples, the defined event type additionally or alternatively corresponds to a particular object recognition indicator associated with the raw video data. The particular object recognition indicator may indicate that a person or object is recognized in one or more video frames of the raw video data. In some examples, the particular object recognition indicator includes a particular classification or label for the person or object that is recognized in the one or more video frames of the raw video data. Furthermore, the process 800 additionally or alternatively includes an operation that configures the respective video processors of the video processor pipeline based at least in part on the particular object recognition indicator.

In some examples, the defined event type additionally or alternatively corresponds to a particular facial recognition indicator associated with the raw video data. The particular facial recognition indicator may indicate that a face is recognized in one or more video frames of the raw video data. In some examples, the particular facial recognition indicator includes a particular classification or label for the face that is recognized in the one or more video frames of the raw video data. Furthermore, the process 800 additionally or alternatively includes an operation that configures the respective video processors of the video processor pipeline based at least in part on the particular facial recognition indicator.

The process 800 also includes an operation 806 that encodes (e.g., by the video processing circuitry 208) video data associated with the at least one video capture device based at least in part on the configuration of the respective video processors. Encoding of the video data may include encoding and not transmitting the video data, encoding and transmitting the video data, or not encoding and not transmitting the video data.

The process 800 also includes an operation 808 that outputs (e.g., by the input/output circuitry 212) the encoded video data to network device. The network device may be a network switch, a user device, a display device, an edge device, or another type of network device.

In some examples, the process 800 additionally or alternatively includes an operation that extracts a video feature set from video data associated with at least one video capture device using a machine learning model associated with the defined event type. In some examples, the process 800 additionally or alternatively includes an operation that outputs the video feature set to the network device. The video feature set may include visual information associated with one or more video frames of video data such as: object detection information, facial features, motion patterns, color distributions, texture information, and/or other visual features represented by one or more video frames of the video data. In some examples, the video feature set may be generated by applying one or more: image processing techniques, computer vision techniques, and/or machine learning techniques to analyze content of the one or more video frames.

In some examples, the process 800 additionally or alternatively includes an operation that generates metadata for video data associated with the at least one video capture device based at least in part on the defined event type. In some examples, the process 800 additionally or alternatively includes an operation that outputs the metadata to the network device. In some examples, the metadata is generated based at least in part on a machine learning model.

In some examples, the process 800 additionally or alternatively includes an operation that determines a transmission schedule for one or more video frames of the encoded video data based at least in part on the defined event type. In some examples, the process 800 additionally or alternatively includes an operation that outputs the encoded video data to the network device based at least in part on the transmission schedule. In some examples, the transmission schedule includes an order and/or timing for a sequence of encoded video frames of the encoded video data. In some examples, the transmission schedule may indicate which encoded video frames are turned on or off during transmission of the encoded video data to the network device. In some examples, the transmission schedule may indicate a frame rate for the encoded video frames of the encoded video data.

In some examples, the process 800 additionally or alternatively includes an operation that configures the video data with a particular format based at least in part on the defined event type.

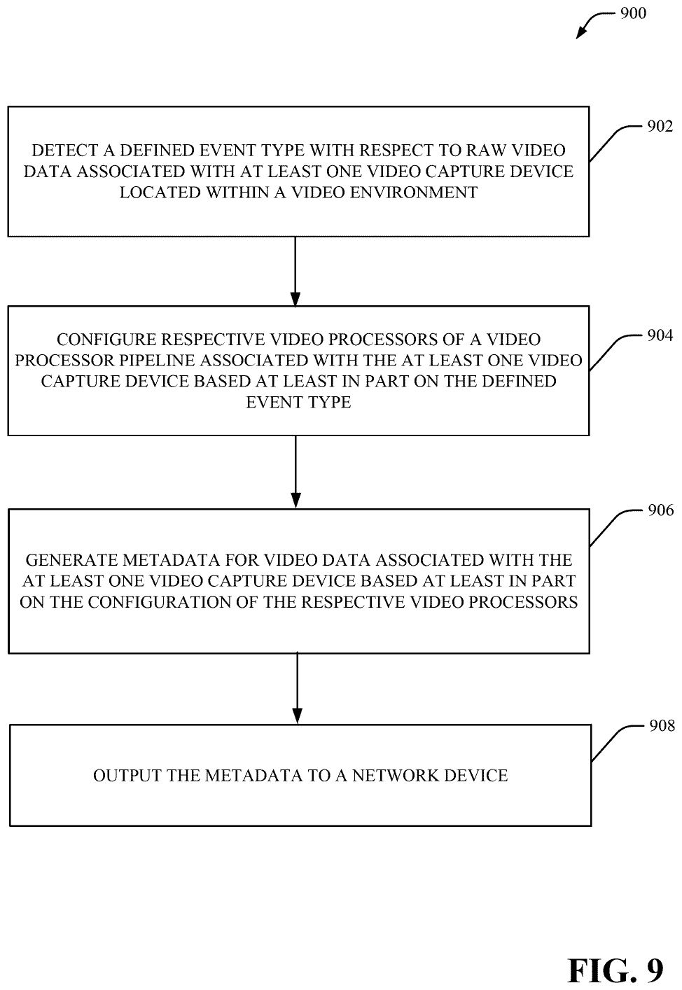

FIG. 9 is a flowchart diagram of an example process 900 for providing a multi-threaded video pipeline for video content associated with a video environment, in accordance with, for example, the AV processing apparatus 202 illustrated in FIG. 2. Via the various operations of the process 900, the AV processing apparatus 202 may enhance quality, reliability, and/or source separation of video data for rendering via a display interface.

The process 900 begins at operation 902 that detects (e.g., by the video processing circuitry 208 and/or the audio processing circuitry 210) a defined event type with respect to raw video data associated with at least one video capture device located within a video environment. The video environment may be an indoor environment, an outdoor environment, an entertainment environment, a room, a conference room, a meeting room, a classroom, a lecture hall, a performance hall, a broadcasting environment, a sports stadium or arena, a virtual environment, an automobile environment, or another type of video environment. The defined event type may include one or more of: a runtime indicator, an event flag, a view score, a person detection indicator, an object detection indictor, a field of view change indicator, an object change indicator, a user device event (e.g., an electronic interface event), a video processor event, or another type of defined event type. In some examples, the defined event type is associated with a user application action associated with a user device. In some examples, the defined event type is associated with a codec action associated with a communication center device communicatively coupled to the at least one video capture device via a network. In some examples, the defined event type is associated with video processor action associated with the video processor pipeline. In some examples, the defined event type is associated with a machine learning model event associated with the video processor pipeline. A machine learning model event may correspond to a particular prediction, insight, inference, and/or classification determined by a machine learning model. In some examples, the defined event type is associated with an audio pipeline action for an audio pipeline associated with the video processor pipeline. In some examples, the defined event type is associated with a machine learning model event associated with an audio pipeline. In some examples, the defined event type is associated with sensor data provided by one or more sensors of the at least one video capture device. For example, the sensor data may include motion sensor data, proximity sensor data, radar sensor data, LiDAR sensor data, and/or other sensor data to facilitate detection of a person or object of interest in the video environment.

The process 900 also includes an operation 904 that configures (e.g., by the video processing circuitry 208) respective video processors of a video processor pipeline associated with the at least one video capture device based at least in part on the defined event type. Configuration of the video processing threads may include: turning particular video processing threads on or off, setting particular parameters for particular video processing threads, initiating particular video related tasks, initiating a particular type of encoding task, initiating a video data acquisition task, initiating execution of a particular machine learning model, enabling speech separation with respect to a video processing thread, modifying one or more video frames associated with a video processing thread, enabling an OCR task associated with one or more video frames associated with a video processing thread, and/or one or more other types of configurations for a video processing thread.

In some examples, the defined event type corresponds to an event indicator set associated with a feature set for the raw video data. For example, the event indicator set may be associated with one or more events with respect to the feature set. An event may include one or more of: an inclusion of a particular type of feature in the feature set, a particular classification or label being determined for a feature in the feature set, a particular number of features in the feature set satisfying a defined threshold value, a particular view score being determined based on the feature set, or another type of event associated with the feature set. Furthermore, the process 800 additionally or alternatively includes an operation that configures the respective video processors of the video processor pipeline based at least in part on the event indicator set.

In some examples, the defined event type additionally or alternatively corresponds to a view score associated with the raw video data. Furthermore, the process 900 additionally or alternatively includes an operation that configures the respective video processors of the video processor pipeline based at least in part on the view score.

In some examples, the defined event type additionally or alternatively corresponds to a particular object recognition indicator associated with the raw video data. The particular object recognition indicator may indicate that a person or object is recognized in one or more video frames of the raw video data. In some examples, the particular object recognition indicator includes a particular classification or label for the person or object that is recognized in the one or more video frames of the raw video data. Furthermore, the process 900 additionally or alternatively includes an operation that configures the respective video processors of the video processor pipeline based at least in part on the particular object recognition indicator.

In some examples, the defined event type additionally or alternatively corresponds to a particular facial recognition indicator associated with the raw video data. The particular facial recognition indicator may indicate that a face is recognized in one or more video frames of the raw video data. In some examples, the particular facial recognition indicator includes a particular classification or label for the face that is recognized in the one or more video frames of the raw video data. Furthermore, the process 900 additionally or alternatively includes an operation that configures the respective video processors of the video processor pipeline based at least in part on the particular facial recognition indicator.

The process 900 also includes an operation 906 that generates (e.g., by the video processing circuitry 208) metadata for video data associated with the at least one video capture device based at least in part on the configuration of the respective video processors. In some examples, the metadata is generated based at least in part on a machine learning model. In some examples, the metadata includes information associated with video frames, video features, object detection features, object classifications, person recognition features, person classifications, three-dimensional coordinates, facial features, mouth features, head pose angles, eye features, eye gaze angles, emotion predictions, active speaking classifications, camera locations, camera poses, depth estimation, color format, frame orientation, frame rotation, natural language processing, video quality, and/or other metadata. In some examples, color format metadata may indicate a type of color format (e.g., RGB, YUV, NV12, etc.) associated with video frames. In some examples, frame orientation metadata may indicate whether video frames are oriented as a landscape orientation or a portrait orientation. In some examples, frame rotation metadata may indicate whether a video frame is rotated horizontally, vertically, diagonally, etc. In some examples, at least a portion of the metadata may be additionally or alternatively provided by the at least one video capture device, at least one audio capture device, a video pipeline engine, and/or an audio pipeline engine.

The process 900 also includes an operation 908 that outputs (e.g., by the input/output circuitry 212) the metadata to a network device. The network device may be a network switch, a user device, a display device, an edge device, or another type of network device.

Although example processing systems have been described in the figures herein, implementations of the subject matter and the functional operations described herein may be implemented in other types of digital electronic circuitry, or in computer software, firmware, or hardware, including the structures disclosed in this specification and their structural equivalents, or in combinations of one or more of them.

Embodiments of the subject matter and the operations described herein may be implemented in digital electronic circuitry, or in computer software, firmware, or hardware, including the structures disclosed in this specification and their structural equivalents, or in combinations of one or more of them. Embodiments of the subject matter described herein may be implemented as one or more computer programs, i.e., one or more modules of computer program instructions, encoded on computer-readable storage medium for execution by, or to control the operation of, information/data processing apparatus. Alternatively, or in addition, the program instructions may be encoded on an artificially-generated propagated signal, e.g., a machine-generated electrical, optical, or electromagnetic signal, which is generated to encode information/data for transmission to suitable receiver apparatus for execution by an information/data processing apparatus. A computer-readable storage medium may be, or be included in, a computer-readable storage device, a computer-readable storage substrate, a random or serial access memory array or device, or a combination of one or more of them. Moreover, while a computer-readable storage medium is not a propagated signal, a computer-readable storage medium may be a source or destination of computer program instructions encoded in an artificially-generated propagated signal. The computer-readable storage medium may also be, or be included in, one or more separate physical components or media (e.g., multiple CDs, disks, or other storage devices).

A computer program (also known as a program, software, software application, script, or code) may be written in any form of programming language, including compiled or interpreted languages, declarative or procedural languages, and it may be deployed in any form, including as a stand-alone program or as a module, engine, component, subroutine, object, or other unit suitable for use in a computing environment. A computer program may, but need not, correspond to a file in a file system. A program may be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program may be deployed to be executed on one computer or on multiple computers that are located at one site or distributed across multiple sites and interconnected by a communication network.

The processes and logic flows described herein may be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory, a random access memory, or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

The term “or” is used herein in both the alternative and conjunctive sense, unless otherwise indicated. The terms “illustrative,” “example,” and “exemplary” are used to be examples with no indication of quality level. Like numbers refer to like elements throughout.

The term “comprising” means “including but not limited to,” and should be interpreted in the manner it is typically used in the patent context. Use of broader terms such as comprises, includes, and having should be understood to provide support for narrower terms, such as consisting of, consisting essentially of, comprised substantially of, and/or the like.

The phrases “in one embodiment,” “according to one embodiment,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment). It is also to be appreciated that the phrase “corresponds to” and/or the phrase “related to” as used herein may be interchangeable with the phrase “associated with.”

While this specification contains many specific implementation details, these should not be construed as limitations on the scope of any disclosures or of what may be claimed, but rather as description of features specific to particular embodiments of particular disclosures. Certain features that are described herein in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in incremental order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems may generally be integrated together in a product or packaged into multiple products.

Thus, particular embodiments of the subject matter have been described. Other embodiments are within the scope of the following claims. In some cases, the actions recited in the claims may be performed in a different order and still achieve desirable results. In addition, the processes depicted in the accompanying figures do not necessarily require the particular order shown, or incremental order, to achieve desirable results, unless described otherwise. In certain implementations, multitasking and parallel processing may be advantageous.

Hereinafter, various characteristics will be highlighted in a set of numbered clauses or paragraphs. These characteristics are not to be interpreted as being limiting on the disclosure or inventive concept, but are provided merely as a highlighting of some characteristics as described herein, without suggesting a particular order of importance or relevancy of such characteristics.

Clause 1. An apparatus comprising at least one processor and a memory storing instructions that are operable, when executed by the processor, to cause the apparatus to: detect a defined event type with respect to raw video data associated with at least one video capture device located within a video environment.

Clause 2. The apparatus of clause 1, wherein the instructions are further operable to cause the apparatus to: configure respective video processors of a video processor pipeline associated with the at least one video capture device based at least in part on the defined event type.

Clause 3. The apparatus of any one of the foregoing clauses, wherein the instructions are further operable to cause the apparatus to: encode video data associated with the at least one video capture device based at least in part on the configuration of the respective video processors.

Clause 4. The apparatus of any one of the foregoing clauses, wherein the instructions are further operable to cause the apparatus to: output the encoded video data to a network device.

Clause 5. The apparatus of any one of the foregoing clauses, wherein the defined event type corresponds to an event indicator set associated with a feature set for the raw video data, and the instructions are further operable to cause the apparatus to: configure the respective video processors of the video processor pipeline based at least in part on the event indicator set.

Clause 6. The apparatus of any one of the foregoing clauses, wherein the defined event type corresponds to a view score associated with the raw video data, and the instructions are further operable to cause the apparatus to: configure the respective video processors of the video processor pipeline based at least in part on the view score.

Clause 7. The apparatus of any one of the foregoing clauses, wherein the defined event type corresponds to a particular object recognition indicator associated with the raw video data, and the instructions are further operable to cause the apparatus to: configure the respective video processors of the video processor pipeline based at least in part on the particular object recognition indicator.

Clause 8. The apparatus of any one of the foregoing clauses, wherein the defined event type corresponds to a particular facial recognition indicator associated with the raw video data, and the instructions are further operable to cause the apparatus to: configure the respective video processors of the video processor pipeline based at least in part on the particular facial recognition indicator.

Clause 9. The apparatus of any one of the foregoing clauses, wherein the instructions are further operable to cause the apparatus to: extract a video feature set from video data associated with at least one video capture device using a machine learning model associated with the defined event type.

Clause 10. The apparatus of any one of the foregoing clauses, wherein the instructions are further operable to cause the apparatus to: output the video feature set to the network device.

Clause 11. The apparatus of any one of the foregoing clauses, wherein the instructions are further operable to cause the apparatus to: generate metadata for video data associated with the at least one video capture device based at least in part on the defined event type.

Clause 12. The apparatus of any one of the foregoing clauses, wherein the instructions are further operable to cause the apparatus to: output the metadata to the network device.

Clause 13. The apparatus of any one of the foregoing clauses, wherein the metadata is generated based at least in part on a machine learning model.

Clause 14. The apparatus of any one of the foregoing clauses, wherein the instructions are further operable to cause the apparatus to: determine a transmission schedule for one or more video frames of the encoded video data based at least in part on the defined event type.

Clause 15. The apparatus of any one of the foregoing clauses, wherein the instructions are further operable to cause the apparatus to: output the encoded video data to the network device based at least in part on the transmission schedule.

Clause 16. The apparatus of any one of the foregoing clauses, wherein the instructions are further operable to cause the apparatus to: configure the video data with a particular format based at least in part on the defined event type.

Clause 17. The apparatus of any one of the foregoing clauses, wherein the defined event type is associated with a user application action that corresponds to a user interaction with respect to a user interface associated with a user device.

Clause 18. The apparatus of any one of the foregoing clauses, wherein the defined event type is associated with a codec action associated with a communication center device communicatively coupled to the at least one video capture device via a network.

Clause 19. The apparatus of any one of the foregoing clauses, wherein the defined event type is associated with a video processor action associated with the video processor pipeline.

Clause 20. The apparatus of any one of the foregoing clauses, wherein the defined event type is associated with a machine learning model event associated with the video processor pipeline.

Clause 21. The apparatus of any one of the foregoing clauses, wherein the defined event type is associated with an audio pipeline action for an audio pipeline associated with the video processor pipeline.

Clause 22. The apparatus of any one of the foregoing clauses, wherein the defined event type is associated with a machine learning model event associated with an audio pipeline.

Clause 23. The apparatus of any one of the foregoing clauses, wherein the defined event type is associated with sensor data.

Clause 24. A computer-implemented method comprising steps in accordance with any one of the foregoing clauses.

Clause 25. A computer program product, stored on a computer readable medium, comprising instructions that, when executed by one or more processors of the audio signal processing apparatus, cause the one or more processors to perform one or more operations related to any one of the foregoing clauses.

Clause 26. An apparatus comprising at least one processor and a memory

storing instructions that are operable, when executed by the processor, to cause the apparatus to: detect a defined event type with respect to raw video data associated with at least one video capture device located within a video environment.

Clause 27. The apparatus of clause 26, wherein the instructions are further

operable to cause the apparatus to: configure respective video processors of a video processor pipeline associated with the at least one video capture device based at least in part on the defined event type.

Clause 28. The apparatus of any one of the foregoing clauses, wherein the instructions are further operable to cause the apparatus to: generate metadata for video data associated with the at least one video capture device based at least in part on the configuration of the respective video processors.

Clause 29. The apparatus of any one of the foregoing clauses, wherein the instructions are further operable to cause the apparatus to: output the metadata to a network device.

Clause 30. A computer-implemented method comprising steps in accordance with any one of the foregoing clauses.

Clause 31. A computer program product, stored on a computer readable medium, comprising instructions that, when executed by one or more processors of the audio signal processing apparatus, cause the one or more processors to perform one or more operations related to any one of the foregoing clauses.

Many modifications and other embodiments of the disclosures set forth herein will come to mind to one skilled in the art to which these disclosures pertain having the benefit of the teachings presented in the foregoing description and the associated drawings. Therefore, it is to be understood that the disclosures are not to be limited to the specific embodiments disclosed and that modifications and other embodiments are intended to be included within the scope of the appended claims. Although specific terms are employed herein, they are used in a generic and descriptive sense only and not for purposes of limitation, unless described otherwise.

That which is claimed is:

1. An apparatus comprising at least one processor and a memory storing instructions that are operable, when executed by the processor, to cause the apparatus to:
detect a defined event type with respect to raw video data associated with at least one video capture device located within a video environment;
configure respective video processors of a video processor pipeline associated with the at least one video capture device based at least in part on the defined event type;
encode video data associated with the at least one video capture device based at least in part on the configuration of the respective video processors; and
output the encoded video data to a network device.

2. The apparatus of claim 1, wherein the defined event type corresponds to an event indicator set associated with a feature set for the raw video data, and wherein the instructions are further operable to cause the apparatus to:
configure the respective video processors of the video processor pipeline based at least in part on the event indicator set.

3. The apparatus of claim 1, wherein the defined event type corresponds to a view score associated with the raw video data, and wherein the instructions are further operable to cause the apparatus to:
configure the respective video processors of the video processor pipeline based at least in part on the view score.

4. The apparatus of claim 1, wherein the defined event type corresponds to a particular object recognition indicator associated with the raw video data, and wherein the instructions are further operable to cause the apparatus to:
configure the respective video processors of the video processor pipeline based at least in part on the particular object recognition indicator.

5. The apparatus of claim 1, wherein the defined event type corresponds to a particular facial recognition indicator associated with the raw video data, and wherein the instructions are further operable to cause the apparatus to:
configure the respective video processors of the video processor pipeline based at least in part on the particular facial recognition indicator.

6. The apparatus of claim 1, wherein the instructions are further operable to cause the apparatus to:
extract a video feature set from video data associated with at least one video capture device using a machine learning model associated with the defined event type; and
output the video feature set to the network device.

7. The apparatus of claim 1, wherein the instructions are further operable to cause the apparatus to:
generate metadata for video data associated with the at least one video capture device based at least in part on the defined event type; and
output the metadata to the network device.

8. The apparatus of claim 7, wherein the metadata is generated based at least in part on a machine learning model.

9. The apparatus of claim 1, wherein the instructions are further operable to cause the apparatus to:
determine a transmission schedule for one or more video frames of the encoded video data based at least in part on the defined event type; and
output the encoded video data to the network device based at least in part on the transmission schedule.

10. The apparatus of claim 1, wherein the instructions are further operable to cause the apparatus to:
configure the video data with a particular format based at least in part on the defined event type.

11. A computer-implemented method comprising:
detecting a defined event type with respect to raw video data associated with at least one video capture device located within a video environment;
configuring respective video processors of a video processor pipeline associated with the at least one video capture device based at least in part on the defined event type;
encoding video data associated with the at least one video capture device based at least in part on the configuration of the respective video processors; and
outputting the encoded video data to a network device.

12. The computer-implemented method of claim 11, wherein the defined event type corresponds to an event indicator set associated with a feature set for the raw video data, and the computer-implemented method further comprising:
configuring the respective video processors of the video processor pipeline based at least in part on the event indicator set.

13. The computer-implemented method of claim 11, wherein the defined event type corresponds to a view score associated with the raw video data, and the computer-implemented method further comprising:
configuring the respective video processors of the video processor pipeline based at least in part on the view score.

14. The computer-implemented method of claim 11, wherein the defined event type corresponds to a particular object recognition indicator associated with the raw video data, and the computer-implemented method further comprising:
configuring the respective video processors of the video processor pipeline based at least in part on the particular object recognition indicator.

15. The computer-implemented method of claim 11, wherein the defined event type corresponds to a particular facial recognition indicator associated with the raw video data, and the computer-implemented method further comprising:
configuring the respective video processors of the video processor pipeline based at least in part on the particular facial recognition indicator.

16. The computer-implemented method of claim 11, further comprising:
extracting a video feature set from video data associated with at least one video capture device using a machine learning model associated with the defined event type; and
outputting the video feature set to the network device.

17. The computer-implemented method of claim 11, further comprising:
generating metadata for video data associated with the at least one video capture device based at least in part on the defined event type; and
outputting the metadata to the network device.

18. The computer-implemented method of claim 11, further comprising:
determining a transmission schedule for one or more video frames of the encoded video data based at least in part on the defined event type; and
outputting the encoded video data to the network device based at least in part on the transmission schedule.

19. The computer-implemented method of claim 11, further comprising:
configuring the video data with a particular format based at least in part on the defined event type.

20. A computer program product, stored on a computer readable medium, comprising instructions that, when executed by one or more processors of an apparatus, cause the one or more processors to:
detect a defined event type with respect to raw video data associated with at least one video capture device located within a video environment;
configure respective video processors of a video processor pipeline associated with the at least one video capture device based at least in part on the defined event type;
encode video data associated with the at least one video capture device based at least in part on the configuration of the respective video processors; and
output the encoded video data to a network device.
